(19) United States
(12) Patent Application Publication
(10) Pub. No.: US 2009/0158792 A1
(43) Pub. Date: Jun. 25, 2009

(54) PADLOCK

(75) Inventor: Jukka Lasaroff, Joensuu (FI)

Correspondence Address: SMITH-HILL AND BEDELL, P.C., 16100 NW CORNELL ROAD, SUITE 220, BEAVERTON, OR, 97006, US

(73) Assignee: ABLOY OY, Joensuu (FI)

(21) Appl. No.: 11/962,537

(22) Filed: Dec. 21, 2007

(51) Int. Cl. E05B 67/24

(52) U.S. Cl. 70/38 A

(57) ABSTRACT

A padlock includes a lock body and a U-shaped shackle fitted in the lock body and movable between a released position and a locked position. A bolt member is disposed in the lock body and cooperates with a turnable force transmission member and the shackle, when the shackle is in the locked position, to retain the shackle in the locked position when the force transmission member is in a first position and to permit the shackle to move to the released position when the force transmission member turns to a second position. A key-actuated cylinder lock mechanism includes turnable locking discs and a control member which acts directly on the force transmission member for turning the force transmission member from the first position to the second position when a lock cylinder is turned from an opening position to a locking position. A spring is effective between the lock cylinder and the force transmission member. The spring is loaded by turning the lock cylinder to the locking position, whereby the spring exerts a force urging the force transmission member back to the first position.

### BACKGROUND OF THE INVENTION

This invention relates to a padlock.

A cylinder lock mechanism provided with turnable locking discs is force-operated and therefore, the opening of the mechanism and the locking thereof do not as such require any spring pressure. In practice, spring pressure may, however, be utilized to make the operation smoother. It is easy to re-key this kind of a lock mechanism and it has good protection against picking. Thus, it may be used advantageously also in padlocks in which high security features are required.

On one hand, user-friendliness is also required from padlocks so that e.g. after opening the lock mechanism there should not be any separate need to pull the shackle out of the lock, but it should be effected by spring-actuation. On the other hand, use of a cylinder lock mechanism with turnable locking discs in a padlock would also be facilitated if the locking of the shackle of the padlock did not necessarily require any key entry. These operations can be easily arranged in pin tumbler based lock mechanisms, in which the opening of the mechanism takes place concurrently with a key being inserted into the lock. In lock mechanisms provided with turnable locking discs the opening of the lock mechanism, as well as the locking thereof, requires that a key of the lock be turned in the lock. Thus, the problem is how to make the operation easier in the above-mentioned way without, at least not substantially, compromising the otherwise good features of a lock mechanism of this kind.

A purpose of the invention is to provide a padlock provided with a cylinder lock mechanism based on turnable locking discs solving the above-described problem so that the lock is easier to use than before and its structure still is as simple as possible. A purpose is also to make the assembly of the lock as easy as possible.

### SUMMARY OF THE INVENTION

In accordance with the present invention there is provided a padlock comprising a lock body formed with a cavity, a substantially U-shaped shackle fitted in the lock body and movable relative to the lock body between a released position, in which the shackle protrudes partially from the lock body, and a locked position, a force transmission means disposed in the lock body and turnable relative to the lock body between a first position and a second position, at least one bolt member disposed in the lock body and cooperating with the force transmission means and the shackle, when the shackle is in the locked position, to retain the shackle in the locked position when the force transmission means is in the first position and to permit the shackle to move to the released position when the force transmission means is in the second position, a key-actuated cylinder lock mechanism fitted in the cavity in the lock body, the cylinder lock mechanism having turnable locking discs and including a lock cylinder that is selectively turnable by a key between a locking position and an opening position and a control member which acts directly on said force transmission means for turning the force transmission means from the first position to the second position when the lock cylinder is turned from the opening position to the locking position, and a spring effective between the lock cylinder and the force transmission means, wherein the spring is loaded by turning the lock cylinder to the locking position, whereby the spring exerts a force urging the force transmission means back to the first position.

The structure according to the invention is simple and the opening of the lock mechanism and the releasing of the shackle are forced operations. By using spring pressure for returning the force transmission means back to the locking position, the key may be turned back to the locking position of the lock mechanism and removed from the lock, whereby the shackle may be locked simply by inserting it into the lock.

In a practical preferable embodiment the force transmission means is provided with a protrusion, which is in the axial direction of the lock cylinder arranged in an overlapping position in force transmission connection with the control member of the lock cylinder.

The spring is preferably a helical spring, one end of which is supported or retained by the lock cylinder and the other end by the force transmission means. The support of the spring may preferably be arranged so as to provide a pre-load for the spring so that the protrusion of the force transmission means and the control member of the lock cylinder are normally pressed against one another. In addition, the lock cylinder is provided with an extension, by which the force transmission means is turnably supported. In this way, the force transmission means and the lock cylinder may be held together as one entity, which is easy to fit into the lock body of the padlock at the assembly stage.

When the shackle is spring-loaded toward its released position protruding from the lock body, there is no separate need to pull the shackle out of the lock body after the lock mechanism has been opened and the force transmission means at the same time turned to the released position.

A structurally simple solution is provided, when the lock cylinder is turnably supported directly by the lock body of the padlock. Then, a locking member, most suitably a tumbler rod, may be arranged for the locking mechanism between the lock cylinder and the lock body.

### BRIEF DESCRIPTION OF THE DRAWINGS

In the following, the invention is explained by way of example with reference to the appended drawings, in which

FIG. 1 shows a general assembly drawing of one padlock embodying the invention,

FIG. 2 shows a sectional view of the padlock according to FIG. 1 assembled and the shackle locked, and

FIG. 3 shows the padlock according to FIG. 2 with the shackle in its released position.

### DETAILED DESCRIPTION

In the drawings the reference number 1 indicates a lock body of the padlock, which is provided with a shackle 2 and a cylinder lock mechanism 4 fitted into a cavity 8 in the lock body, which lock mechanism is secured inside the lock body 1 by means of a cover 11. The cylinder lock mechanism 4 acts on a turnable force transmission means 10, which controls the operation of bolt members 9 to provide the locking of the shackle 2 of the lock. The shackle has a longer leg and a shorter leg and is provided with recesses 2a in each leg for receiving the bolt members 9.

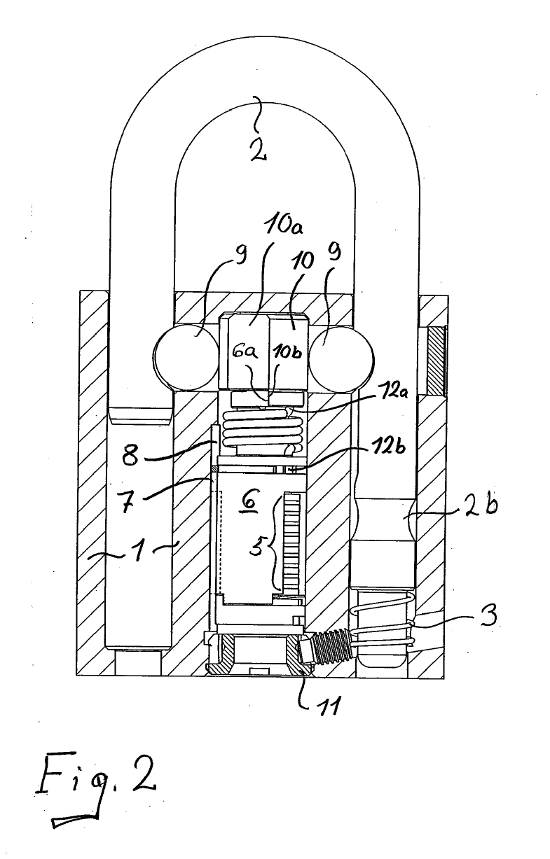

The operating principle of the cylinder lock mechanism 4 is known as such. The cylinder lock mechanism comprises a lock cylinder 6 enclosing a plurality of locking discs 5 and also comprises a tumbler rod 7, which prevents the turning of the lock cylinder 6 relative to the lock body 1 when the lock mechanism is in the locked position. This corresponds to the locked position of the padlock shown in FIG. 2, where the shackle 2 is locked in the lock body 1 by the force transmission means 10 and bolt members 9.

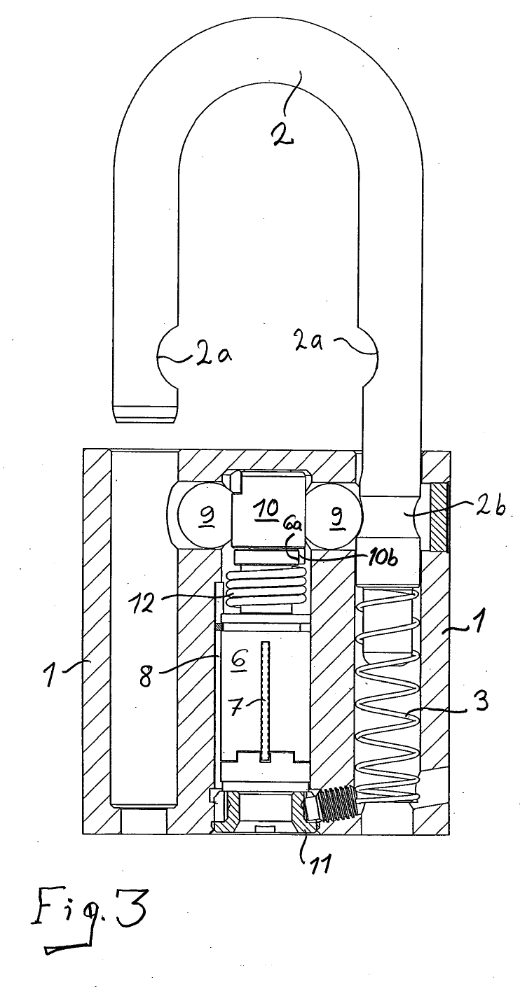

The lock mechanism may be opened in known manner by a key (not shown) of the lock, whereby the tumbler rod 7 releases the lock cylinder 6 so that it is allowed to turn with the key. The lock cylinder 6 is provided with a control member 6a, which acts on a protrusion 10b of the force transmission means 10 and thus turns the force transmission means 10 to a position in which its recesses 10a face the bolt members 9. Consequently, the spring 3 of the shackle 2 presses the bolt members 9 into the recesses 10a at the same time as it presses the shackle 2 out of the lock body 1 to the position shown in FIG. 3 in which the shorter leg of the shackle is free of the lock body. A recess 2b in the longer leg of the shackle prevents the shackle 2 from being totally removed from the lock body 1.

In the operating position shown in FIG. 3 the cylinder lock mechanism 4 is turnable by a key of the lock back to the locked position according to FIG. 2. This is done when the aim is to remove the key from the padlock after releasing the shackle 2. Then the force transmission means 10 stays in its place, since one of the bolt members 9, together with the longer leg of the shackle, prevents its turning.

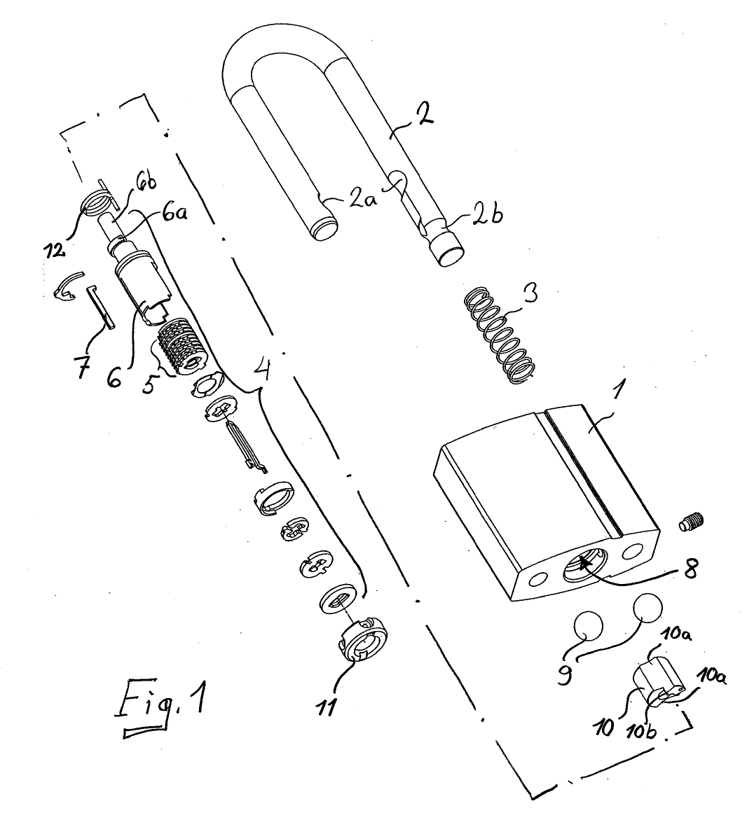

According to the invention, the padlock is provided with a spring 12 arranged at the rear (inner) end of the lock cylinder 6, one end 12a of which spring is supported or retained by the force transmission means 10 and the other end 12b by the lock cylinder 6. When the lock cylinder 6 has been turned from the opening position according to FIG. 3 to the locking position of the lock mechanism according to FIG. 2, the key may be removed from the padlock The tumbler rod 7 secures the lock cylinder 6 against turning relative to the lock body 1. By turning the lock cylinder from the opening position to the locking position, the spring 12 is loaded. The spring 12 remains in this condition when the key is removed, as its one end 12a is fixed into the immovable force transmission means 10 and as the lock cylinder 6 is also immovable, secured by the tumbler rod 7. When the shackle 2 is in this situation inserted into the lock body 1, the bolt members 9 are allowed to enter the recesses 2a of the shackle thus locking the shackle 2 and at the same time releasing the force transmission means 10 so that it may turn, urged by the spring 12, back to the locking position of the tumbler member 9 according to FIG. 1. Thus, no key is required in this situation for locking the shackle 2, but the locking is urged by the pressure of the spring 12.

The illustrated padlock is simple in its structure and is easy to assemble. The spring 12 is fitted into its place between the lock cylinder 6 and the force transmission means 10 without any tools. It is then advantageous to arrange a slight pre-load for the spring 12, whereby the control member 6a is pressed against the protrusion 10b. The lock cylinder 6 is also provided with an extension 6b, by which the force transmission means 10 may be turnably supported. In this way the entity remains stable and may easily be fitted into the lock body 1.

The invention is not limited to the illustrated embodiment, but several variations are conceivable within the scope of the appended claims.

1. A padlock comprising:
a lock body formed with a cavity,
a substantially U-shaped shackle fitted in the lock body and movable relative to the lock body between a released position, in which the shackle protrudes partially from the lock body, and a locked position,
a force transmission means disposed in the lock body and turnable relative to the lock body between a first position and a second position,
at least one bolt member disposed in the lock body and cooperating with the force transmission means and the shackle, when the shackle is in the locked position, to retain the shackle in the locked position when the force transmission means is in the first position and to permit the shackle to move to the released position when the force transmission means is in the second position,
a key-actuated cylinder lock mechanism fitted in the cavity in the lock body, the cylinder lock mechanism having turnable locking discs and including a lock cylinder that is selectively turnable by a key between a locking position and an opening position and a control member which acts directly on said force transmission means for turning the force transmission means from the first position to the second position when the lock cylinder is turned from the locking position to the opening position, and
a helical spring having one end retained by the lock cylinder and an opposite end retained by the force transmission means, wherein the spring is loaded by turning the lock cylinder to the locking position, whereby the spring exerts a force urging the force transmission means back to the first position.

2. A padlock according to claim 1, wherein the spring is a helical spring having one end retained by the lock cylinder and an opposite end retained by the force transmission means.

3. A padlock according to claim 1, wherein the force transmission means comprises a protrusion which overlaps the control member of the lock cylinder in the axial direction of the lock cylinder and is in force transmission connection with the control member of the lock cylinder.

4. A padlock according to claim 3, wherein the spring is pre-loaded when the lock cylinder is in the locking position so that the protrusion of the force transmission means and the control member of the lock cylinder are normally pressed against one another.

5. A padlock according to claim 1, wherein the lock cylinder includes an extension that turnably supports the force transmission means.

6. A padlock according to claim 1, wherein the shackle is spring-loaded toward its released position.

7. A padlock according to claim 1, wherein the lock cylinder is turnably supported directly by the lock body of the padlock.

8. A padlock according to claim 7, wherein the lock mechanism includes a locking member arranged functionally between the lock cylinder and the lock body.

9. A padlock according to claim 8, wherein the lock cylinder is turnably supported directly by the lock body of the padlock, and the locking mochanlom member comprises a tumbler rod arranged functionally between the lock cylinder and the lock body.
